(19) United States
(12) Patent Application Publication
(10) Pub. No.: US 2023/0185299 A1
(43) Pub. Date: Jun. 15, 2023

(54) AIRBORNE DATACENTER

(71) Applicant: INTERNATIONAL BUSINESS MACHINES CORPORATION, Armonk, NY (US)

(72) Inventors: Tamojit Das, Stamford, CT (US); Paritosh Ranjan, Kolkata (IN)

(21) Appl. No.: 17/551,145

(22) Filed: Dec. 14, 2021

(51) Int. Cl. G05D 1/00; B64C 39/02

(52) U.S. Cl. CPC G05D 1/0027; B64C 39/024; G05D 1/0022; B64C 2201/12

(57) ABSTRACT

An airborne datacenter (ADC) device includes a datacenter assembly component (DAC) and a drive apparatus. The DAC is configured to perform: provisioning the ADC including receiving, in response to a provision request, business functions and configuration information from a provisioning center connected to the ADC over a network and self-configuring the ADC with the business functions and the configuration information; datacenter operations with the ADC including receiving, from another ADC within a fleet of ADCs and over the network, processing results generated by the another ADC, performing the datacenter operations using the business functions and the processing results generated by the another ADC, and forwarding processing results of the datacenter operations to a land-based enterprise over the network; and decommissioning the ADC including transferring runtime information of the ADC, and deleting the runtime information from the ADC. The DAC includes digital processing equipment configured to perform the business functions.

### BACKGROUND

The present invention relates to datacenters, and more specifically, to a continuously-airborne datacenter.

As the term is used herein, a “datacenter” is where digital processing equipment, such as servers, workstations, firewalls, network devices, etc. are housed. Additionally, a single datacenter may constitute one or more of such digital processing equipment, either co-located or separately located. Generally, a datacenter has a very large footprint and is considered to be more or less a fixed asset for any enterprise. Since a datacenter can be located in one or multiple rooms/floors within a building, scalability becomes an issue when demands fluctuate. Consequently, a current problem with existing datacenters is the ability to elastic in terms of demand.

In addition to electronic devices, a datacenter is significantly dependent upon utilities such as electrical power, cooling, dehumidification, and the like. Regardless of the amount of equipment kept within a datacenter, they need all need cooling and dehumidification. Consequently, when the datacenter is expanded (e.g., by adding additional digital processing equipment), power consumption, cooling and dehumidification, and the like to support the additional equipment is also increased. Once expanded, an enterprise is typically locked into supporting all of the equipment and utilities added—even if the demand that initiated the expansion subsequent decreases. Requiring an enterprise to support all of this equipment, even if not needed/used, drives up costs of operations.

Another issue associated with physical datacenters is a need for the datacenter to be able to withstand natural and manmade disasters. These requirements involve for additional reinforcements, physical security, locating the datacenter at strategic places, among others. Despite these measures, significant risks still exist and can barely be mitigated. Consequently, there is a need for a datacenter that can be quickly provisioned subsequent to any disaster, that can also quickly scale up to the needs of high demands (i.e., demand bursts) as well as being able to scale down when such demands subside. This ability would help an enterprise optimize datacenter operations in addition to reduce the cost of such operations.

### SUMMARY

A computer-implemented process within an airborne datacenter (ADC) device including a datacenter assembly component (DAC) and a drive apparatus includes the following. The ADC device is provisioned. Datacenter operations are performed with the ADC device. The ADC device is decommissioned. The provisioning includes receiving, in response to a provision request, business functions and configuration information from a provisioning center connected to the ADC device over a network, and self-configuring the ADC device with the business functions and the configuration information. The performing the datacenter operations includes receiving, from another ADC device within a fleet of ADC devices and over the network, processing results generated by the another ADC device, performing the datacenter operations using the business functions and the processing results generated by the another ADC device, and forwarding processing results of the datacenter operations to a land-based enterprise over the network. The decommissioning includes transferring runtime information of the ADC device and deleting the runtime information from the ADC device. The DAC includes digital processing equipment configured to perform the business functions.

An airborne datacenter (ADC) device includes a datacenter assembly component (DAC) and a drive apparatus. The DAC is configured to perform: provisioning the ADC device including receiving, in response to a provision request, business functions and configuration information from a provisioning center connected to the ADC device over a network and self-configuring the ADC device with the business functions and the configuration information; datacenter operations with the ADC device including receiving, from another ADC device within a fleet of ADC devices and over the network, processing results generated by the another ADC device, performing the datacenter operations using the business functions and the processing results generated by the another ADC device, and forwarding processing results of the datacenter operations to a land-based enterprise over the network; and decommissioning the ADC device including transferring runtime information of the ADC device, and deleting the runtime information from the ADC device. The DAC includes digital processing equipment configured to perform the business functions.

A computer program product comprises a computer readable storage medium having stored therein program code. The program code, which when executed by an airborne datacenter (ADC) device including a datacenter assembly component (DAC) and a drive apparatus, cause the ADC device to perform the following. The ADC device is provisioned. Datacenter operations are performed with the ADC device. The ADC device is decommissioned. The provisioning includes receiving, in response to a provision request, business functions and configuration information from a provisioning center connected to the ADC device over a network, and self-configuring the ADC device with the business functions and the configuration information. The performing the datacenter operations includes receiving, from another ADC device within a fleet of ADC devices and over the network, processing results generated by the another ADC device, performing the datacenter operations using the business functions and the processing results generated by the another ADC device, and forwarding processing results of the datacenter operations to a land-based enterprise over the network. The decommissioning includes transferring runtime information of the ADC device and deleting the runtime information from the ADC device. The DAC includes digital processing equipment configured to perform the business functions.

During the decommissioning, the ADC device can be configured to transfer runtime information of the ADC device to a different ADC device within the fleet. Also, the ADC device can be configured to act as a node in a network that includes the fleet of ADC devices. During the performing the datacenter operations, new business functions are received by the ADC device from the provisioning center over the network. The digital processing equipment can be configured to self-execute the new business function. The ADC device can be operably connected to a land-based datacenter using the network, and the datacenter operations performed by the ADC device support operations of the land-based datacenter.

Additionally, the DAC includes a chassis surrounding a power supply, a cooling component, and the digital processing equipment, and the ADC includes a mounting hanger positioned between the DAC and the drive apparatus. The mounting hanger can be configured to permit the DAC to be releasably-attached to the drive apparatus, and the mounting hanger includes a power connector between the ADC and the drive apparatus and a data connector between the ADC and the drive apparatus. The power connector can be configured to allow transfer of power between the ADC and the drive apparatus. The data connector can be configured to allow two-way transfer of data between the ADC and the drive apparatus. The drive apparatus can be an unmanned aerial vehicle.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of an airborne datacenter device according to an embodiment of the present invention.

FIGS. 2A, 2B respectively illustrate a physical architecture and logical architecture of the airborne datacenter device including a provision control system and one or more airborne datacenter devices 100 according to an embodiment of the present invention.

FIGS. 3A, 3B are block diagrams illustrating a provisioning center according to an embodiment of the present invention.

FIG. 4 is a block diagram illustrating an exemplary method of employing the airborne datacenter device, provision control system, and provisioning center of FIGS. 1-3 according to an embodiment of the present invention.

FIG. 5 is a block diagram further illustrating exemplary post-airborne operations found in FIG. 4 according to an embodiment of the present invention.

FIGS. 6A, 6B respectively illustrating exemplary provisioning an decommissioning operations found in FIG. 4 according to an embodiment of the present invention.

FIG. 7 is a block diagram illustrating an example of computer hardware system for implementing one or more of the DAC, PCS, DCS, and LCS of FIGS. 2A-2B, 3A-3B.

FIG. 8 depicts a cloud computing environment according to an embodiment of the present invention.

FIG. 9 depicts abstraction model layers according to an embodiment of the present invention.

### DETAILED DESCRIPTION

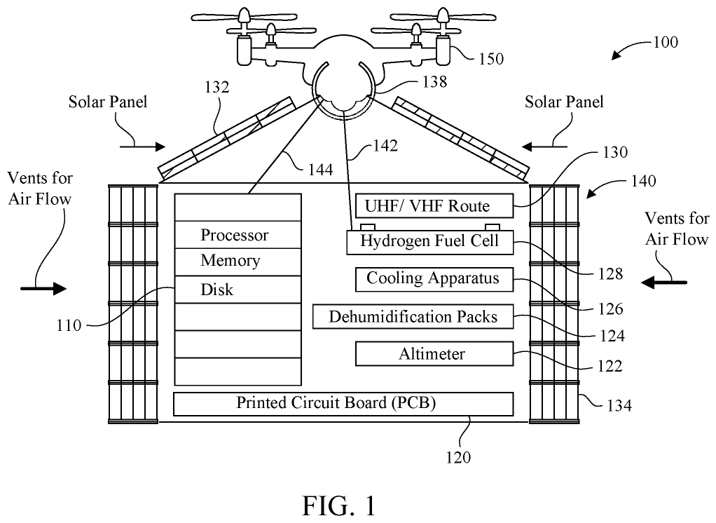

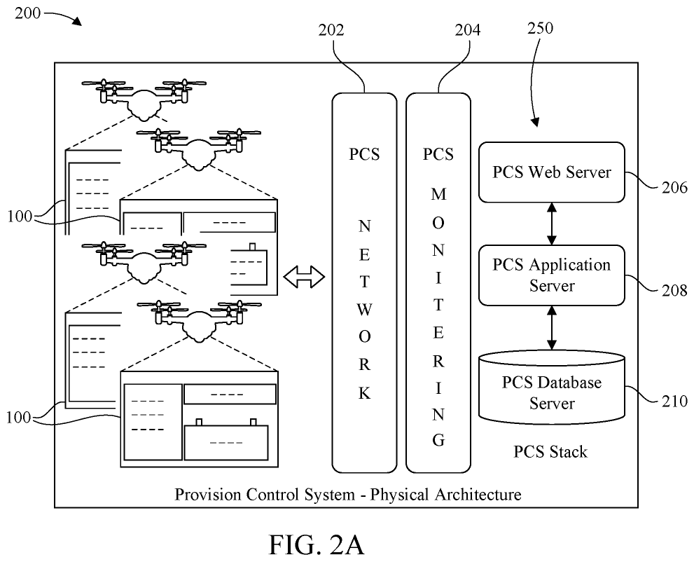

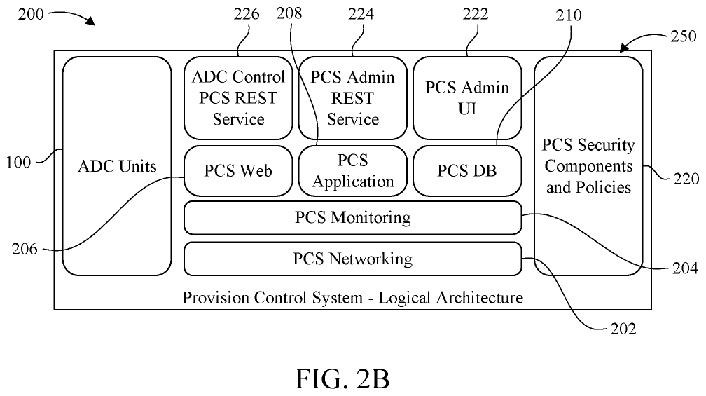

FIG. 1 illustrates an exemplary airborne datacenter (ADC) device 100 of the airborne datacenter 200 (illustrated in FIG. 2). As discussed elsewhere, this ADC device 100, either alone or in combination with other ADC devices 100, provide the core functionality of the airborne datacenter 200. Although not limited to limited to the specific components described herein, many aspects of the ADC device 100 includes the components described below. With an airborne datacenter 200, an enterprise 330 can quickly respond to both increased and decreased demands. For example, after a disaster, the demands of the airborne datacenter 200 increases as land-based datacenters may be inaccessible, and as the infrastructure is repaired, the need for the airborne datacenter 200 becomes lesser.

In certain aspects, the functionality of the airborne datacenter 200 center is provided by a number of ADC devices 100 that include hardware/software components consistent with the functions provided by a land-based datacenter. While capable of operating as a standalone datacenter, the airborne datacenter 200 can also serve as an extension to a preexisting land-based datacenter of an enterprise 330. In so doing, the land-based datacenter and the airborne datacenter 200 are connected and operate together via a network 202.

As with a normal datacenter, the ADC device 100 includes the digital processing equipment 110 required to perform the known functions of a land-based datacenter, such as with one or more processors, memory, and physical storage, such as a hard drive/disk. The digital processing equipment 110 can be connected to specialized equipment of the ADC device 100 using a purpose-built circuit board (PCB) 120 that is configured to connect with multiple components 122-130 in a modular fashion using plug-and-play (PnP) capability. For example, the PCB 120 could provide connection for multi-processors and multiple storage devices as part of the digital processing equipment. 110.

The specialized equipment of the ADC device 100 can include an altimeter 122, dehumidification components 124, cooling apparatus 126, power/electrical supply 128, communication device 130, cooling vents, solar panels 132, and a drive apparatus 134. The altimeter 122 or other type of elevation measuring device is used to maintain the ADC device 100 at a selected/desired elevation. The dehumidification component 124 could be an active/powered device or a passive device (e.g., a packet of desiccant). The cooling apparatus 126 is not limited as to a particular configuration, and includes any cooling apparatus 126 capable of maintaining the inside of the ADC device 100 at a desired temperature. As is conventionally known, the dehumidification component 124 and the cooling apparatus 126 can be integrated together. In addition to or alternatively, a cage/chassis 134 surrounding and supporting the components can be configured to permit surrounding air to flow through the cage/chassis 134 to cool the components, for example, via vents. In certain aspects, the chassis 134 includes anti-static, lightweight material. In a box-configuration, two parallel sides of the chassis 134 includes airflow vents angled at 45° upward and the other two parallel sides of the chassis 134 includes airflow vents angled at 45° downward. Airflow into the chassis 134 can be regulated using hovering adjustments.

The electrical supply 128 can be any device capable of providing electrical power. In certain aspects, the electrical supply 128 is rechargeable. Examples of an electrical supply 128 so capable could include a hydrogen fuel cell and/or a battery (e.g., a Lithium-ion battery). The ADC device 100 can also include solar panels 132 that can supply electrical power to the other electrical components within the ADC device 100 and/or recharge the electrical supply 128.

The ADC device 100 includes one or more communication devices 130. The communication device 130 permits the ADC device 100 to establish network connectivity to an electronic network 202 including, for example, an enterprise private network associated with the enterprise 330. A communication device 130 so capable are known, and the ADC device 100 is not limited as to particular type. For example, the communication device 130 can operate on dual frequencies (e.g., UHF and VHF). In certain aspects, the communication device can reduce communication overhead by operating using z-wave or Zibgee technology.

The ADC device 100 includes a drive apparatus 150, which is the mechanism by which the ADC device 100 takes flight. Many types of drive apparatus 140 so capable are known and the ADC device 100 is not limited as to a particular type. For example, the drive apparatus 140 can be a low-flying aircraft or balloon. However, in certain aspects, the drive apparatus 150 is a unmanned aerial vehicle (UAV)/remote piloted aircraft system (RPAS). A UAV (commonly referred to a drone) is an unmanned vehicle that can be remotely controlled and/or fly autonomously. UAVs are commercially available, and the present ADC device 100 is not limited as to a particular type of UAV.

In certain aspects, the cage/chassis 134 including all of the components 110, 120-132 (hereinafter referred to as the datacenter assembly component (DAC) 140 is releasably-connected to the drive apparatus/drone 136 using mounting hangers 138 or an equivalent mechanical device. Specifically, many types of mechanical devices are capable of allowable two objects to be connected and then subsequently disconnected, and the present ADC device 100 is not limited as to a particular device so capable.

The mounting hanger 138, besides providing a mechanical connection between the DAC 140 and the UAV 150, can also provide a power and/or data connectors 142, 144 between the DAC 140 and the UAV 150. The power connector 142 is configured to allow the power supply 128 for both the DAC 140 and the UAV 150 to be positioned solely within either the DAC 140 or UAV 150. Alternatively, the power supply 128 of the DAC 140 can share power with the power supply (not shown) of the UAV 150 and vice versa. Additionally, the provision of a data connector 144 can allow for certain components to be placed within the DAC 140 or UAV 150. For example, an altimeter 124 or communication device 130 may already be integrated within the UAV 150, and consequently, the DAC 140 can use these components 124, 130 found within the UAV 150 instead of native requiring these components. Additionally, a data connector 144 permits the UAV 150 to inform the DAC 140 of certain status information (e.g., power available, error conditions) that can be used to determine the continued viability of the UAV 150 to keep the DAC 140 aloft. Many types of devices capable of providing a data connector 144 are known, and the present ADC device 100 is not limited as to a particular type.

By providing the ability to detach the DAC 140 from the UAV 150, the DAC 140 can be removed from one UAV 150 and placed on a different UAV 150 having different capabilities. For example, if the ADC device 100 was only intended to be airborne for a short period of time, a smaller-sized UAV 150 may be selected. Alternatively, if the ADC device 100 was intended to be aloft for an extended prior of time, a larger-sized UAV 150, capable of longer flight time, may be selected. Consequently, the combination of DAC 140 and UAV 150 making up the ADC device 100 can be variable based upon, for example, needed flight capabilities of the instance in which the ADC device 100 is deployed.

Reference is made to FIGS. 2A, 2B, which illustrate certain aspects of an airborne data center 200. Specifically, FIGS. 2A and 2B respectively illustrate a physical architecture and logical architecture of the airborne data center 200 including a provision control system (PCS) components 204-210 and one or more airborne datacenter (ADC) devices 100. The PCS components can include a PCS web server 206, a PCS application server 208, and a PCS database server 210. The PCS web server 206 is front-facing system configured to respond to data requests, for example, web content request via a browser. The PCS application server 208 is configured to run applications that that support the PCS web server 206. The PCS database server 210 is backend database application configured to provide the data that supports both the PCS web server 206 and PCS application server 208. These components 206, 208, 210 can be distributed separately or integrated together in one or more hardware servers. Additionally, the PCS components 204-210 support the implementation of PCS applications 222-226. The PCS applications can include a PCS administration user interface 222, a PCS rest service 224, and a PCS control service 226.

The PCS administrative user interface 222 is a web application configured to enable human interaction for administration of the PCS 250. The PCS administrative user interface 222 can also be used for defining commissioning, decommissioning and launch parameters/settings. The PCS rest service 224 is configured to automate the commissioning/decommissioning of the ADC devices 100, for example, in situations when human interaction via the PCS administrative user interface 222 is not possible. The PCS control service 226 is ab interface for interaction with the ADC devices 100, ADC business functions as well as controlling the ADC devices 100 on an as needed basis.

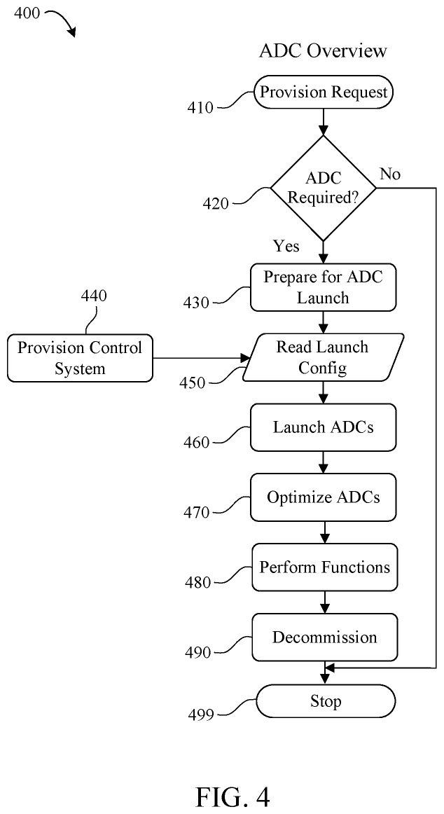

Also included can be PCS security components and policies 220, which is a database that includes contains configuration parameters for the launch, definition of the business functions, security settings on communications with the PCS 250, and communication settings among other ADC devices 100 for secure exchange of data. Operation of the PCS components 204-210 and PCS applications 222-226 are discussed in more detail with respect to the operations illustrated in FIGS. 4-6.

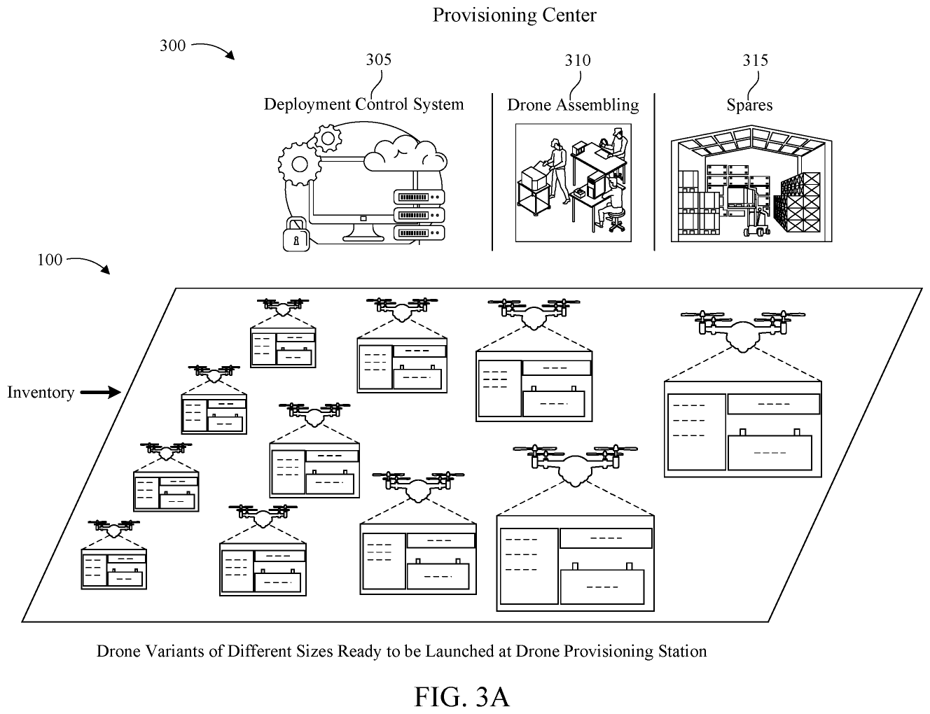

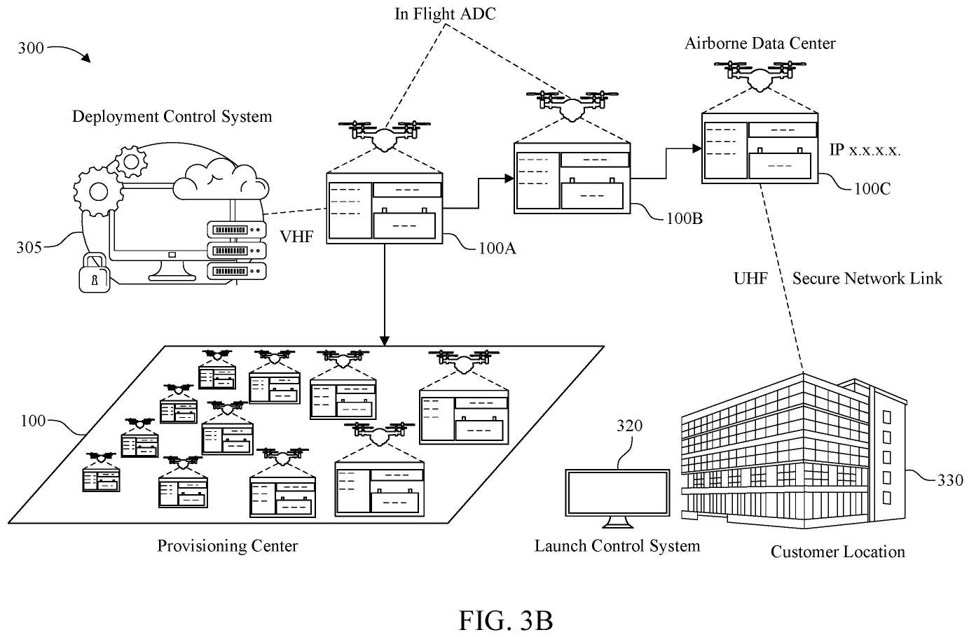

The PCS monitoring device 204 is configured to gather operational metrics that can be used to measure performance, health, etc. of the ADC devices 100. These operation metrics can include but are not limited to hardware performance, resource utilization, and need for additional resources. These operational metrics can delivered directly from the ADC devices 100 to the PCS monitoring device 204 over network 202. The network 202 is not limited as to a particular type. However, in certain aspects all data exchanged over the network 202 is encrypted regardless of the protocol used. This includes data between the ADC devices 100 and the PCS system 250 as well as communications between the various devices illustrated in FIGS. 3A-3B.

Reference is made to FIGS. 3A-3B, which illustrate a provisioning center 300 and ADC a fleet of ADC devices 100A-C in operation in accordance with certain aspects of the present disclosure. In general, the provision center 300 can be configured to perform multiple functions including building/assembly of ADC devices 100, configuring the ADC devices 100, setting up the ADC devices 100 with security artifacts for secure network connectivity once airborne, configuring the ADC devices 100 to serve specific business functions, maintaining an inventory/pool of the ADC devices 100 as well as dependent components, spares, and the like.

The provisioning center 300 can include an inventory of various types and/or capabilities of ADC devices 100, and those ADC devices 100 can be registered with the Federal Aviation Administration (FAA) for the N-number or local aviation authorities for other countries. The provisioning center 300 can also include a deployment control system (DCS) 305 that manages deployment of the ADC devices 100 including, for example, configuration, maintenance, and launching. The DCS 305 is configured to interact with on-premise launch infrastructure as well as a launch control system (LCS) 320. The provisioning center 300 can also include facilities for drone assembly 310 and spares 315 to support the provisioning of the ADC devices.

In certain aspects, the provisioning center 300 can include the LCS 320, which can be separate from or integrated into the DCS 305. Alternatively, the LCS 320 can be located with the enterprise 330. In certain aspects, the LCS 320 can operate on a platform agnostic hardware, be mobile, and/or be hosted from within a private enterprise network or in the cloud. Interaction between the LCS 320 and launch infrastructure can be over the enterprise private network and remain secure through network segmentation and/or using a site-to-site virtual private network. The LCS 320 can include all launch parameters, which can be made available remotely and securely to the launch infrastructure and compliant with all Federal Aviation Administration (FAA) directives specifically for unmanned aircrafts when operating in the United States. Similar compliance can be driven by local aviation authorities for other countries.

In certain aspects, the DCS 305 is configured to gather operational metrics that can be used to measure performance, health, etc. of the ADC devices 100. These operation metrics can include but are not limited to hardware performance, resource utilization, and need for additional resources. These operational metrics can delivered directly from the ADC devices 100 to the DCS 305 over network 202 and/or received from the PCS monitoring device 204. In addition to making real-time determinations as to whether certain ADC devices 100 are to be decommissioned and/or replaced, these operational metrics can be subsequently used by a neural network to identify patterns that can be used to determine configuration patterns for subsequently-deployed ADC devices 100. The operational metrics can also include location information, which will allow the DCS 305 to position each individual ADC device 100 within the deployed fleet 100A-C in a desired location.

With reference to FIG. 4, an overview of the general process 400 for implementing the ADC device(s) 100 is disclosed. In 410, a provision request for one or more ADC devices 100 is received by the PCS 250. The provision request may be received, for example, from a computer associated with an enterprise 330. Alternatively, the provision request may be initiated from the PCS 250 alone or in conjunction with one or more of the ADC devices 100. For example, a determination may be made either be the PCS 250 and/or the ADC device 100 that the processing power/function of an existing fleet 100A-C of ADC devices 100 needs to be increased.

Although not limited in this manner, the provision request can includes such data as: requesting entity, start time, end time, requirements pursuant to a service level agreement, capacity, functional requirements, and the like. In 420, a determination is made, based upon the provision request, whether launching of one or more ADC devices 100 are required. If not, the process 400 ends at 499.

The general process 400 can continue to be implemented even after a fleet 100A-C of ADC devices 100 have been deployed. For example, the LCS 320, in conjunction with input from the enterprise 330, may determine that additional ADC devices 100 are required for the fleet. In this instance, an additional/supplemental provision request may be issued to supplement fleet 100A-C, which will lead to additional ADC devices 100 being provisioned by the PCS 250 pursuant to the general process 400 illustrated in FIG. 4.

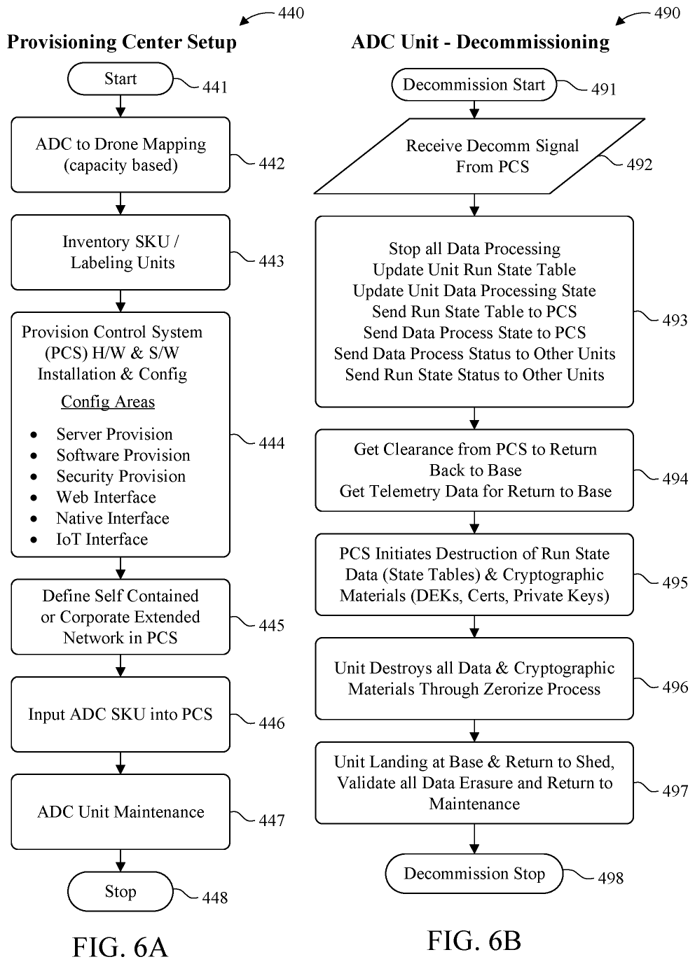

In 430, after a determination is made that one or more ADC devices 100 are required, the ADC devices 100 are prepared for launch. The provisioning 440, by the PCS 200, and configuration 450 of the ADC devices is discussed in more detail with regard to FIG. 6A.

In 460, the one or more ADC devices 100 are launched. The DCS 300 can interact with the LCS 320 whereby operators can manually activate launches or launches can be automated based upon previously-gathered demands metrics.

In certain aspects, the LCS 320 is a software component that interacts with the DCS 300 to launch the ADC devices 100. The LCS 320 can be configured to support non-interactive and/or interactives mode of operation. In non-interactive mode, the LCS 320 can employ historic runtime models gathered through machine learning and supplemented by artificial intelligence integration. In an interactive mode, the LCS 320 can be controlled manually. Both interactive and non-interactive modes of operation can be used to effectively launch the ADC devices 100 as well as make adjustments thereto. The LCS 320 in conjunction with the DSC 305 can also include launch infrastructure such as pre-programmed tracks than can guide the ADC devices 100 from a storage/maintenance location 310 to a launch pad.

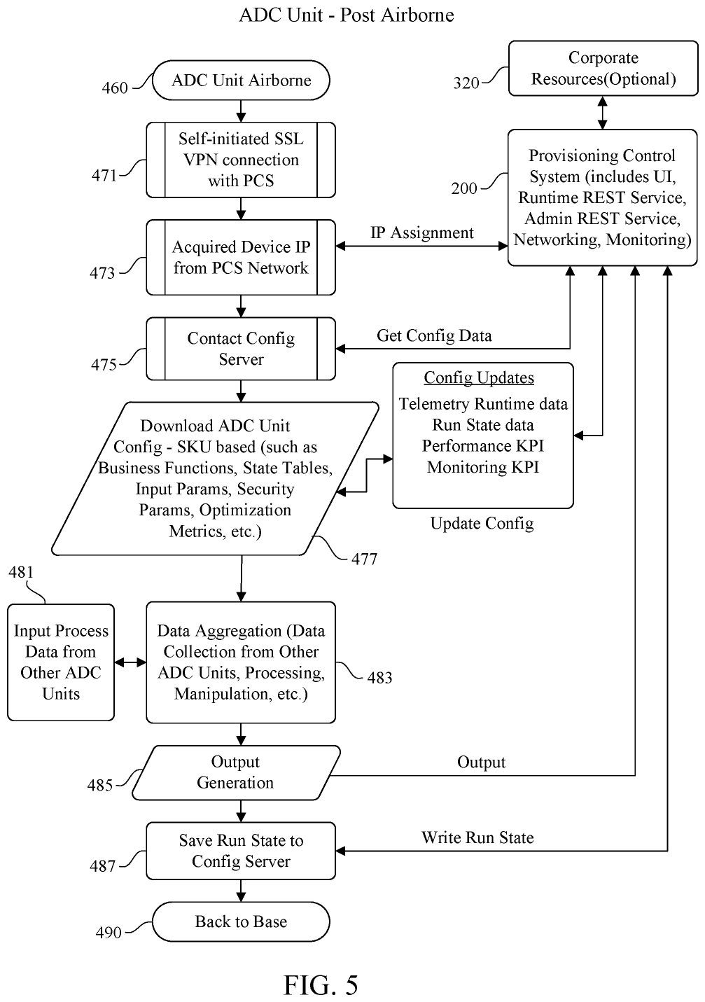

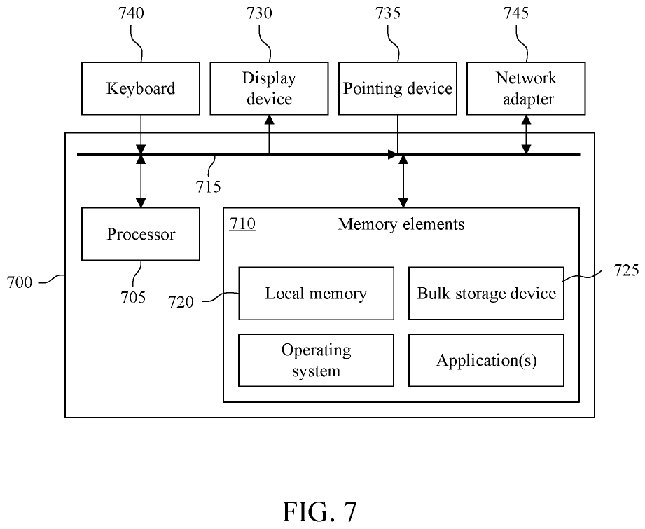

The operations involving optimizing 470 the ADC devices 100 and the ADC devices 100 performing functions of a data center 480 are discussed in more detail with regard to FIG. 5. The operations associated with decommissioning 490 the ADC devices 100 are discussed in more detail with regard to FIG. 7A. In 499, the process 400 ends.

With reference to FIG. 5, an exemplary methodology for optimizing the ADC devices and performing the function of a data center 480 is disclosed. The process begins after the ADC device 100 is airborne in 460. In 471, the ADC device can self-initiate a communication connection with the PCS 250 using the network 202 (e.g., the enterprise private network) established by the PCS 250. Although not limited in this manner, the communication can be an encrypted communication, for example, using a secure sockets layer (SSL) protocol over a virtual private network (VPN). Other types of encrypted communication forms can alternatively be used. After the connection with the PCS 250 has been established, in 473, the ADC device 100 can acquire a network address (e.g., an IP address) from the PCS 250.

In 475, the ADC device 100 can request configuration information to be downloaded from the PCS 200. The configuration information can be based upon the unique identifier (e.g., SKU) associated with each ADC device 100. The configuration information can be defined, in part, by the provision request discussed with regard to 410. The configuration information can include but is not limited to information related to business functions, state tables, input parameters, security parameters, optimization metrics and the like. The configuration information can also include executables that will permit to ADC device 100 to perform specific business functions. The self-configuring of the ADC device with the business functions and configuration information can occur prior to and/or after the ADC device 100 has

In 481, although not limited in this manner, each business function can be configured to optimize its own performance based upon the available resources within the individual ADC device 100 to which the business function is being deployed. Additionally, the business functions can be configured to be distributed within the individual ADC devices 100 of the fleet 100A-C. In so doing, the individual ADC devices 100 can communicate with one another and share/coordinate runtime results with one another. Additionally, as needed, one or more new business functions can be remotely injected into individual ones of the ADC devices 100. In so doing, the digital processing equipment 110 is configured to self-configured and self-execute the new business function.

In 483, the data from the ADC devices 100 can be aggregated together. For example, the processing results of one ADC device 100A can be used as input for a different ADC device 100A. In 485, the processing results of the fleet of ADC devices 100A-C are distributed, consistent with how a conventional land-based datacenter will operation. The processing results, for example, can be forwarded to the enterprise 330. Additionally, in 487, the PCS 200 can store the run state of each ADC device 100 within a configuration server.

With reference to FIG. 6A, an exemplary methodology 440 for provisioning one or more ADC devices 100 consistent with the process 400 illustrated in FIG. 4 is disclosed. After the process starts in 441, a determination of the number of ADC devices 100 needed in the fleet 100A-C are determined in 442. The number of ADC devices 100 is based upon the demands of the enterprise 330, as communicated to the PCS 250 via the launch control system 320, for example, within the provision request.

In 443, individual ones of the ADC devices 100 are given unique identifiers by which the individual ones of the ADC devices 100 can be tracked. Although not limited in this manner the unique identifiers can be a stock keeping unit (SKU) number, a label, or a media access control (MAC) address.

In 444, the PCS 250 initiates the software and hardware installation/configuration of the ADC device 100. The hardware installation can includes matching the DAC 140 to a particular UAV 150. For example, a larger UAV 150 may be required if the intended flight time is extended beyond the capabilities of a smaller UAV 150. Additionally, software can be loaded and installed into the DAC 140 of the ADC 100. This software can include, for example, bootstrapping software, cryptographic service provider libraries, networking software, business function libraries, component monitoring, logging libraries, network authentication parameters, x509 certificates, virtual private network client and the like. This software supports server functions, security functions, and supporting software functions. The software can also support one or more interfaces, such as a web interface, a native interface, and an internet-of-things (IoT) interface.

In 445, the PCS 250 can define a self-contained or corporate-extended network/enterprise private network 202 with which the ADC devices 100 communicate. This process is comparable to setting up a conventional network with multiple processing nodes. In 446, each of the multiple processing nodes of the are assigned, by the PCS 250, to one of the identifiers associated with each of the ADC devices 100. In 447, any pre-flight maintenance can be performed after which the provisioning center setup is completed in 448.

With reference to FIG. 6B, an exemplary methodology 490 for decommissioning one or more ADC devices 100 consistent with the process 400 illustrated in FIG. 4 is disclosed. The start 491 of the decommissioning process involves the ADC device 100 receiving a decommissioning signal initiated by the PCS 250. The decommissioning signal can be received via the communication device 130 directly from the PCS 250 or indirectly via an antenna (not shown) or from other airborne ADC devices 100 within which the ADC device 100 to be decommissioned is in communication with. Alternatively, the decommissioning signal can be internally generated based upon some condition being met. For example, a decommissioning signal can be internally generated based upon the ADC device 100 being aloft for a predetermined amount of time or the power available to the DAC 140 and/or UAV 150 has dropped to a certain level.

In certain aspects, the decommissioning signal involves the fleet 100A-C of ADC devices 100 being maintained but one or more of these ADC devices 100 being replaced. For example, a particular ADC device 100 may be running low on power and cannot stay aloft for much longer. In this instance, as discussed in 493, the ADC device 100 can transfer runtime information of the ADC device 100 (e.g., state table, data processing state, run state status) to one or more other ADC devices in the fleet 100A-C of ADC devices 100. This can include sharing its runtime information with pre-existing ADC device 100 within the fleet 100A-C and/or sharing its runtime information with a newly-configured ADC device 100 in order to keep the same launch parameters associated with the ADC device 100 to be decommissioned. In this manner, continuity of the business functions of the ADC device 100 can be maintained prior to the ADC device 100 being decommissioned.

In 493, the operations of the ADC device 100 as a data center component are wrapped up. The wrapping up can include: stopping all data processing, updating a unit run state table, updating unit data processing state, sending runtime information to PCS 250, sending data processing status to one or more other ADC devices 100, and/or sending run state status to one or more other ADC devices 100. In 494, after the data processing operations have been concluded and wrapped up, the ADC device 100 can receive clearance from the PCS 250 to return to the provisioning center 300. This can also include receiving telemetry data.

Sometime after 493 has been concluded and possibly concurrently with 494, the PCS 250 can provide the ADC device 100 with a signal to initiate erasure of data stored locally within the ADC device 100 including the runtime information. The data being erased can include all business sensitive data. Additionally, the data being erased can include initial launch parameters, run state data (i.e., state tables) as well as cryptographic information such as data encryption keys (DEK), certifications, and private keys. In 496, after the erasure signal has been received, the ADC device 100 can commence erasure of the data using any appropriate technique, for example, using a zeroisation process. In certain aspects, this data erasure can return the ADC device 100 to a pre-initialization state.

In 497, the ADC device 100 reaches the provisioning center 200. At this point, the ADC device can report the landing to the PCS 250. Once landed, maintenance can be performed on the ADC device 100. This can include remotely-performed maintenance, such as software upgrades, security enhancements, cryptographic secrets and material injection, among other. The maintenance can also include mechanical maintenance such as separating the DAC 140 from the UAV 150 and servicing individual components of each. In 498, the decommissioning process concludes.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “server” means a data processing system configured to share services with one or more other data processing systems.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

FIG. 7 is a block diagram illustrating example architecture for a data processing service 700 for executing the any of the PCS 250, LCS 320, and DCS 305. The data processing system 700 can include at least one processor 705 (e.g., a central processing unit) coupled to memory elements 710 through a system bus 715 or other suitable circuitry. As such, the data processing system 700 can store program code within the memory elements 710. The processor 705 can execute the program code accessed from the memory elements 710 via the system bus 715. It should be appreciated that the data processing system 700 can be implemented in the form of any system including a processor and memory that is capable of performing the functions and/or operations described within this specification. For example, the data processing system 700 can be implemented as a server, a plurality of communicatively linked servers, a workstation, a desktop computer, a mobile computer, a tablet computer, a laptop computer, a netbook computer, a smart phone, a personal digital assistant, a set-top box, a gaming device, a network appliance, and so on.

The memory elements 710 can include one or more physical memory devices such as, for example, local memory 720 and one or more bulk storage devices 725. Local memory 720 refers to random access memory (RAM) or other non-persistent memory device(s) generally used during actual execution of the program code. The bulk storage device(s) 725 can be implemented as a hard disk drive (HDD), solid state drive (SSD), or other persistent data storage device. The data processing system 700 also can include one or more cache memories (not shown) that provide temporary storage of at least some program code in order to reduce the number of times program code must be retrieved from the local memory 720 and/or bulk storage device 725 during execution.

Input/output (I/O) devices such as a display 730, a pointing device 735 and, optionally, a keyboard 740 can be coupled to the data processing system 700. The I/O devices can be coupled to the data processing system 700 either directly or through intervening I/O controllers. For example, the display 730 can be coupled to the data processing system 700 via a graphics processing unit (GPU), which may be a component of the processor 705 or a discrete device. One or more network adapters 745 also can be coupled to data processing system 700 to enable the data processing system 700 to become coupled to other systems, computer systems, remote printers, and/or remote storage devices through intervening private or public networks. Modems, cable modems, transceivers, and Ethernet cards are examples of different types of network adapters 745 that can be used with the data processing system 700.

As pictured in FIG. 7, the memory elements 710 can store the components of the any of the PCS 250, LCS 320, and DCS 305. Being implemented in the form of executable program code, these components of the data processing system 700 can be executed by the data processing system 700 and, as such, can be considered part of the data processing system 700.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

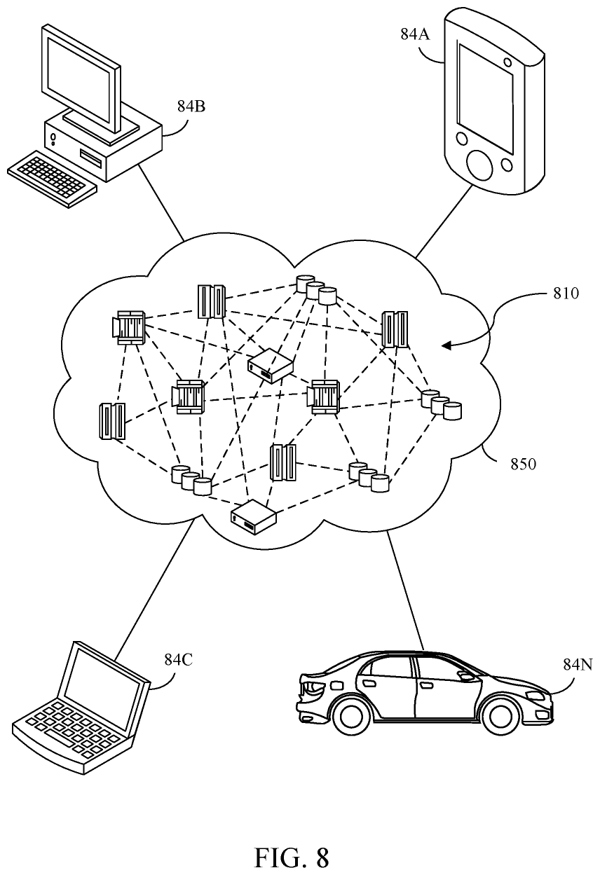

Referring now to FIG. 8, illustrative cloud computing environment 850 to be used with the ADaaS toolset is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

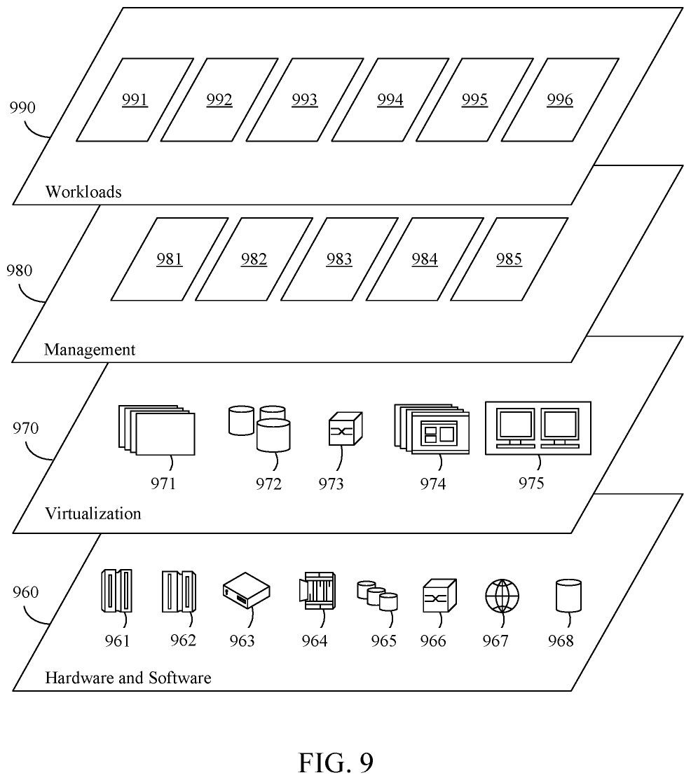

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and operations of the any of the PCS, LCS, and DCS 996.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented process within an airborne datacenter (ADC) device including a datacenter assembly component (DAC) and a drive apparatus, comprising:
provisioning the ADC device;
performing datacenter operations with the ADC device; and
decommissioning the ADC device, wherein
the provisioning includes:
receiving, in response to a provision request, business functions and configuration information from a provisioning center connected to the ADC device over a network, and
self-configuring the ADC device with the business functions and the configuration information,
the performing the datacenter operations includes:
receiving, from another ADC device within a fleet of ADC devices and over the network, processing results generated by the another ADC device,
performing the datacenter operations using the business functions and the processing results generated by the another ADC device,
forwarding processing results of the datacenter operations to a land-based enterprise over the network,
the decommissioning includes:
transferring runtime information of the ADC device, and
deleting the runtime information from the ADC device, and
the DAC includes digital processing equipment configured to perform the business functions.

2. The method of claim 1, wherein
during the decommissioning, the ADC device is configured to transfer runtime information of the ADC device to a different ADC device within the fleet.

3. The method of claim 1, wherein
the ADC device is configured to act as a node in a network that includes the fleet of ADC devices.

4. The method of claim 1, wherein
during the performing the datacenter operations, new business functions are received by the ADC device from the provisioning center over the network, and
the digital processing equipment is configured to self-execute the new business function.

5. The method of claim 1, wherein
the ADC device is operably connected to a land-based datacenter using the network,
the datacenter operations performed by the ADC device support operations of the land-based datacenter.

6. The method of claim 1, wherein
the DAC includes a chassis surrounding a power supply, a cooling component, and the digital processing equipment.

7. The method of claim 1, wherein
the ADC device includes a mounting hanger positioned between the DAC and the drive apparatus, and
the mounting hanger is configured to permit the DAC to be releasably-attached to the drive apparatus.

8. The method of claim 7, wherein
the mounting hanger includes a power connector between the ADC and the drive apparatus and a data connector between the ADC device and the drive apparatus,
the power connector is configured to allow transfer of power between the ADC device and the drive apparatus, and
the data connector is configured to allow two-way transfer of data between the ADC device and the drive apparatus.

9. The method of claim 1, wherein
the drive apparatus is an unmanned aerial vehicle.

10. An airborne datacenter (ADC) device, comprising:
a datacenter assembly component (DAC), and
a drive apparatus, wherein the DAC is configured to perform:
provisioning the ADC device;
performing datacenter operations with the ADC device; and
decommissioning the ADC device,
the provisioning includes:
receiving, in response to a provision request, business functions and configuration information from a provisioning center connected to the ADC device over a network, and
self-configuring the ADC device with the business functions and the configuration information,
the performing the datacenter operations includes:
receiving, from another ADC device within a fleet of ADC devices and over the network, processing results generated by the another ADC device,
performing the datacenter operations using the business functions and the processing results generated by the another ADC device,
forwarding processing results of the datacenter operations to a land-based enterprise over the network,
the decommissioning includes:
transferring runtime information of the ADC device, and
deleting the runtime information from the ADC device, and
the DAC includes digital processing equipment configured to perform the business functions.

11. The ADC device of claim 10, wherein
during the decommissioning, the ADC device is configured to transfer runtime information of the ADC device to a different ADC device within the fleet.

12. The ADC device of claim 10, wherein
the ADC device is configured to act as a node in a network that includes the fleet of ADC devices.

13. The ADC device of claim 10, wherein
during the performing the datacenter operations, new business functions are received by the ADC device from the provisioning center over the network, and
the digital processing equipment is configured to self-execute the new business function.

14. The ADC device of claim 10, wherein
the ADC device is operably connected to a land-based datacenter using the network,
the datacenter operations performed by the ADC device support operations of the land-based datacenter.

15. The ADC device of claim 10, wherein
the DAC includes a chassis surrounding a power supply, a cooling component, and the digital processing equipment.

16. The ADC device of claim 10, wherein
the ADC device includes a mounting hanger positioned between the DAC and the drive apparatus, and
the mounting hanger is configured to permit the DAC to be releasably-attached to the drive apparatus.

17. The ADC device of claim 16, wherein
the mounting hanger includes a power connector between the ADC device and the drive apparatus and a data connector between the ADC device and the drive apparatus,
the power connector is configured to allow transfer of power between the ADC device and the drive apparatus, and
the data connector is configured to allow two-way transfer of data between the ADC device and the drive apparatus.

18. The ADC device of claim 10, wherein
the drive apparatus is an unmanned aerial vehicle.

19. A computer program product, comprising:
a computer readable storage medium having stored therein program code,
the program code, which when executed by an airborne datacenter (ADC) device including a datacenter assembly component (DAC) and a drive apparatus, cause the ADC device to perform:
provisioning the ADC device;
performing datacenter operations with the ADC device; and
decommissioning the ADC device,
the provisioning includes:
receiving, in response to a provision request, business functions and configuration information from a provisioning center connected to the ADC device over a network, and
self-configuring the ADC device with the business functions and the configuration information, the performing the datacenter operations includes:
receiving, from another ADC device within a fleet of ADC devices and over the network, processing results generated by the another ADC device,
performing the datacenter operations using the business functions and the processing results generated by the another ADC device,
forwarding processing results of the datacenter operations to a land-based enterprise over the network,
the decommissioning includes:
transferring runtime information of the ADC device, and
deleting the runtime information from the ADC device, and
the DAC includes digital processing equipment configured to perform the business functions.

20. The computer program product of claim 19, wherein
the DAC includes a chassis surrounding a power supply, a cooling component, and the digital processing equipment,
the ADC device includes a mounting hanger positioned between the DAC and the drive apparatus,
the mounting hanger is configured to permit the DAC to be releasably-attached to the drive apparatus,
the mounting hanger includes a power connector between the ADC device and the drive apparatus and a data connector between the ADC device and the drive apparatus,
the power connector is configured to allow transfer of power between the ADC device and the drive apparatus,
the data connector is configured to allow two-way transfer of data between the ADC device and the drive apparatus, and
the drive apparatus is an unmanned aerial vehicle.
